(19) United States
(12) Patent Application Publication
(10) Pub. No.: US 2025/0291341 A1
(43) Pub. Date: Sep. 18, 2025

(54) SERVER DEVICE AND VEHICLE

(71) Applicant: TOYOTA JIDOSHA KABUSHIKI KAISHA, Toyota-shi (JP)

(72) Inventors: Daiki YOKOYAMA, Miyoshi-shi (JP); Jyunya KATOU, Toyota-shi (JP)

(73) Assignee: TOYOTA JIDOSHA KABUSHIKI KAISHA, Toyota-shi (JP)

(21) Appl. No.: 19/051,375

(22) Filed: Feb. 12, 2025

(30) Foreign Application Priority Data
Mar. 12, 2024 (JP) 2024-037902

(51) Int. Cl. G05B 19/418; B25J 9/00; B62D 65/18; G05D 1/225; G05D 101/00; G05D 105/45; G05D 107/70

(52) U.S. Cl. CPC G05B 19/41895; B25J 9/0093; G05D 1/225; B62D 65/18; G05B 2219/31001; G05B 2219/50393; G05D 2101/22; G05D 2105/45; G05D 2107/70

(57) ABSTRACT

A server device includes a command generation unit that generates a running command for controlling running of a vehicle by unmanned driving; a command transmission unit that controls transmission of the running command to the vehicle; a stopping detection unit that detects that the vehicle has been stopped at an assembly position where a part is assembled onto the vehicle; and a stopping unit that performs at least one of a process of stopping the generation of the running command by the command generation unit, a process of stopping the transmission of the running command by the command transmission unit, and a process of transmitting to the vehicle a deactivation command that disables the running command, when it is detected that the vehicle has been stopped at the assembly position.

### CROSS REFERENCE TO RELATED APPLICATIONS

This application claims priority to Japanese Patent Application No. 2024-037902, filed Mar. 12, 2024, the disclosure of which is incorporated by reference herein in its entirety.

### BACKGROUND

### Field

The present disclosure relates to a server device and a vehicle.

There are known technologies for causing vehicles under production to run by unmanned driving (for example, U.S. Patent Application Publication No. 2021/0394780).

When parts are being assembled onto a vehicle that has been stopped, if the vehicle starts running again, the assembly of the parts may fail.

### SUMMARY

The present disclosure may be realized by the following aspects.

(1) According to a first aspect of the present disclosure, a server device is provided. The server device includes a command generation unit that generates a running command for controlling running of a vehicle by unmanned driving; a command transmission unit that controls transmission of the running command to the vehicle; a stopping detection unit that detects that the vehicle has been stopped at an assembly position where a part is assembled onto the vehicle; and a stopping unit that performs at least one of a process of stopping the generation of the running command by the command generation unit, a process of stopping the transmission of the running command by the command transmission unit, and a process of transmitting to the vehicle a deactivation command that disables the running command, when it is detected that the vehicle has been stopped at the assembly position.

The server device according to this aspect makes it possible to prevent the vehicle that has been stopped from restarting the running while a part is being assembled onto the vehicle. This prevents failure in parts assembly.

(2) The server device according to the above aspect may further include an assembly detection unit that detects that assembly of the part has been completed; and a restarting unit that performs at least one of a process of restarting the process or processes stopped by the stopping unit and a process of transmitting to the vehicle an activation command that activates the running command, when it is detected that the assembly of the part has been completed.

The server device according to this aspect makes it possible to move the vehicle for which the assembly of the part has been completed by unmanned driving.

(3) In the server device according to the above aspect, the assembly detection unit may detect that the assembly of the part has been completed using information acquired from an assembly device that assembles the part onto the vehicle.

The server device according to this aspect detects that the assembly has been completed using the information acquired from the assembly device, thereby more easily accurately detecting that the assembly of the part by the assembly device has been completed.

(4) In the server device according to the above aspect, the assembly device may include an arm unit that assembles the part onto the vehicle, and the assembly detection unit may detect that the assembly of the part has been completed using information regarding a state of the arm unit acquired from the assembly device.

The server device according to this aspect makes it possible to detect that the assembly of the part has been completed using the information regarding the state of the arm unit.

(5) In the server device according to the above aspect, the state of the arm unit may be a state regarding a position and an orientation of the arm unit.

The server device according to this aspect makes it possible to prevent the vehicle that starts running from the assembly position from coming into contact with the arm unit.

(6) In the server device according to the above aspect, the state of the arm unit may be a state whether the arm unit is gripping the part.

The server device according to this aspect makes it possible to prevent the vehicle from start running with the arm unit gripping the part. Therefore, the arm unit can be prevented from being dragged by the vehicle.

(7) In the server device according to the above aspect, the assembly detection unit may detect that the assembly of the part has been completed using information acquired from an external sensor located outside the vehicle.

The server device according to this aspect makes it possible to detect that the assembly of the part has been completed using the information acquired from the external sensor. Further, it is also possible to detect that the assembly of the part has been completed even when workers assemble the part manually.

(8) In the server device according to the above aspect, the assembly detection unit may detect that the assembly of the part has been completed using a pass/fail determination result regarding the assembly of the part.

The server device according to this aspect makes it possible to detect that the assembly of the part has been completed using the pass/fail determination result. Further, it is also possible to detect that the assembly of the part has been completed even when workers assemble the part manually.

(9) In the server device according to the above aspect, the command generation unit may generate the running command for causing the vehicle to run to a repair place if the pass/fail determination result shows a result indicating failure.

The server device according to this aspect makes it possible to automatically move the vehicle with assembly failure to a repair place.

(10) In the server device according to the above aspect, the assembly detection unit may detect that the assembly of the part has been completed using information transmitted from the vehicle when the part has been assembled.

The server device according to this aspect makes it possible to detect that the assembly of the part has been completed using the information transmitted from the vehicle. Further, it is also possible to detect that the assembly of the part has been completed even when workers assemble the part manually.

(11) The server device according to the above aspect may further include a position information generation unit that generates position information of the vehicle, the command generation unit may generate the running command using the position information, the stopping unit may perform a process of stopping the generation of the running command by the command generation unit when it is detected that the vehicle has been stopped at the assembly position, and the position information generation unit may continue the generation of the position information while the generation of the running command by the command generation unit is being stopped by the stopping unit.

The server device according to this aspect makes it possible to use the position information of the vehicle for purposes other than the running of the vehicle.

(12) According to a second aspect of the present disclosure, a vehicle capable of running by unmanned driving is provided. The vehicle includes an actuator that causes the vehicle to run; a command generation unit that generates a running command for controlling running of the vehicle by unmanned driving; a control unit that drives the actuator using the running command; a stopping detection unit that detects that the vehicle has been stopped at an assembly position where a part is assembled onto the vehicle; and a stopping unit that performs at least one of a process of stopping the generation of the running command by the command generation unit, and a process of stopping the driving of the actuator using the running command by the control unit, when it is detected that the vehicle has been stopped at the assembly position.

With the vehicle according to this aspect, it is possible to prevent the vehicle that has been stopped from restarting the running while a part is being assembled onto the vehicle. This prevents failure in parts assembly.

(13) According to a third aspect of the present disclosure, a vehicle control method is provided. The control method generates a running command for controlling running of the vehicle by unmanned driving, transmits the running command to the vehicle, and performs at least one of a process of stopping the generation of the running command, a process of stopping the transmission of the running command, and a process of transmitting to the vehicle a deactivation command that disables the running command, when it is detected that the vehicle has been stopped at an assembly position where a part is assembled onto the vehicle.

The control method according to this aspect makes it possible to prevent the vehicle that has been stopped from restarting the running while a part is being assembled onto the vehicle. This prevents failure in parts assembly.

(14) According to a fourth aspect of the present disclosure, a vehicle control method is provided. This control method generates a running command for controlling running of the vehicle by unmanned driving, drives an actuator that causes the vehicle to run using the running command, and performs at least one of a process of stopping the generation of the running command and a process of stopping the driving of the actuator using the running command, when it is detected that the vehicle has been stopped at an assembly position where a part is assembled onto the vehicle.

The control method according to this aspect makes it possible to prevent the vehicle that has been stopped from restarting the running while a part is being assembled onto the vehicle. This prevents failure in parts assembly.

The present disclosure may also be implemented in various aspects other than server devices, vehicles, and control methods. For example, the present disclosure may also be realized in aspects as a computer program, a storage medium storing a computer program, and the like.

### BRIEF DESCRIPTION OF THE DRAWINGS

FIG. 1 is an explanatory view showing a structure of a system of a first embodiment;

FIG. 2 is an explanatory view showing a structure of a vehicle of the first embodiment;

FIG. 3 is an explanatory view showing a structure of a server device of the first embodiment;

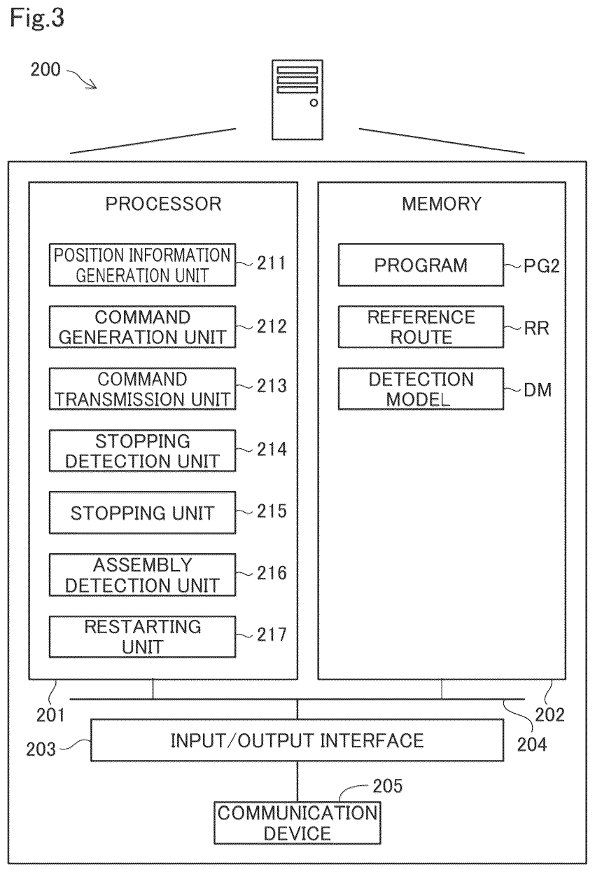

FIG. 4 is an explanatory view showing a structure of an assembly robot of the first embodiment;

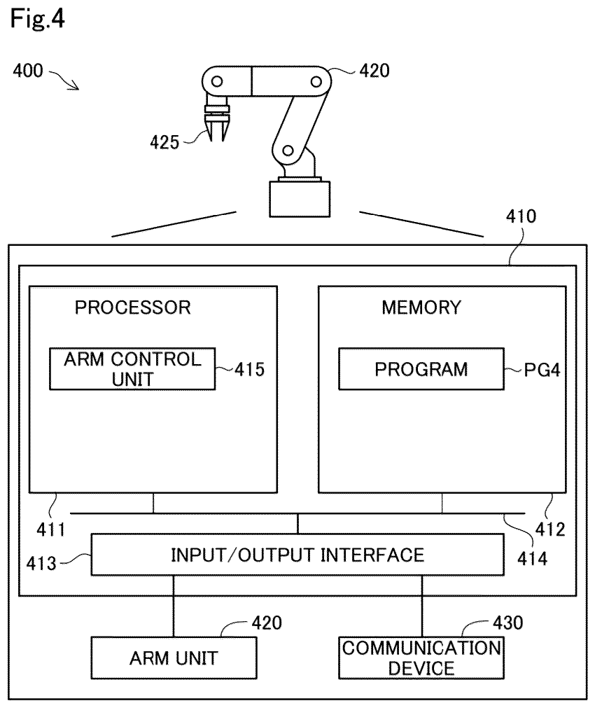

FIG. 5 is a first flowchart showing procedures in the process of running control of a vehicle in the first embodiment;

FIG. 6 is a second flowchart showing procedures in the process of running control of a vehicle in the first embodiment;

FIG. 7 is a first flowchart showing procedures in the process of stop flag switching control in the first embodiment;

FIG. 8 is a second flowchart showing procedures in the process of stop flag switching control in the first embodiment;

FIG. 9 is an explanatory view showing a state in which a part is assembled onto a vehicle of the first embodiment;

FIG. 10 is a first flowchart showing procedures in the process of running control of a vehicle in a second embodiment;

FIG. 11 is a second flowchart showing procedures in the process of running control of a vehicle in the second embodiment;

FIG. 12 is a first flowchart showing procedures in the process of deactivation flag switching control in the second embodiment;

FIG. 13 is a second flowchart showing procedures in the process of deactivation flag switching control in the second embodiment;

FIG. 14 is an explanatory view showing a state in which parts are assembled onto a vehicle of the second embodiment;

FIG. 15 is an explanatory view showing a structure of a system of a third embodiment;

FIG. 16 is an explanatory view showing a structure of a vehicle of the third embodiment;

FIG. 17 is a flowchart showing procedures in the process of running control of a vehicle in the third embodiment;

FIG. 18 is a first flowchart showing procedures in the process of stop flag switching control in the third embodiment; and

FIG. 19 is a second flowchart showing procedures in the process of stop flag switching control in the third embodiment.

### DETAILED DESCRIPTION

### A. First Embodiment

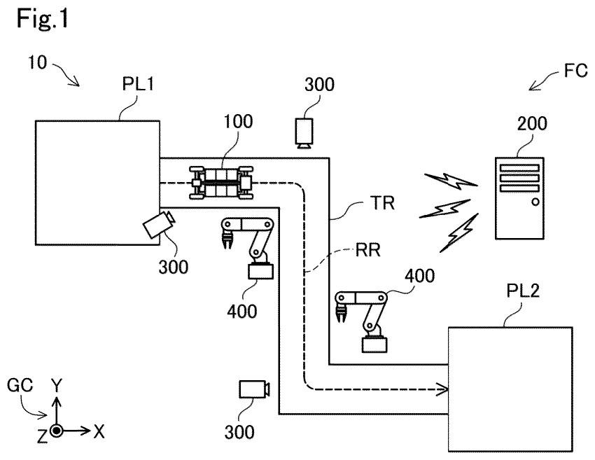

FIG. 1 is an explanatory view showing a structure of a system 10 according to a first embodiment. The system 10 includes a vehicle 100, which is a moving object, a server device 200, at least one external sensor 300, and at least one assembly robot 400.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a truck, a bus, a two-wheel vehicle, a four-wheel vehicle, a combat vehicle, or a construction vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 100 is configured to be capable of running by unmanned driving. The “unmanned driving” means driving independent of running operation by a passenger. The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”

In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

In the present embodiment, the system 10 is used in a factory FC where the vehicle 100 is produced. The reference coordinate system of the factory FC is a global coordinate system GC, and any location in the factory FC is expressed with X, Y, and Z coordinates in the global coordinate system GC. The factory FC has a first place PL1 and a second place PL2. The first place PL1 and the second place PL2 are connected by a track TR on which the vehicle 100 can run. In the factory FC, a plurality of external sensors 300 and a plurality of assembly robots 400 are provided along the track TR. The position of each external sensor 300 in the factory FC is adjusted in advance. The vehicle 100 moves from the first place PL1 to the second place PL2 through the track TR by unmanned driving.

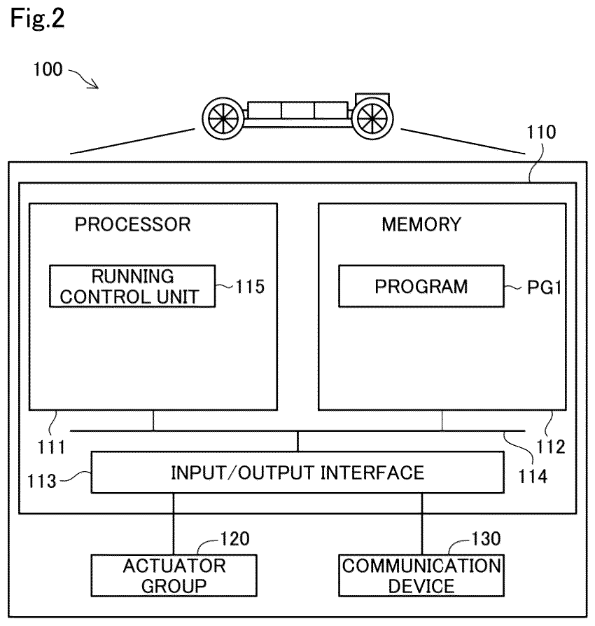

FIG. 2 is an explanatory view showing a structure of the vehicle 100 in the present embodiment. FIG. 2 shows a vehicle 100 in the form of so-called a platform. In the present embodiment, the vehicle 100 is an electric vehicle and is structured to enable itself to run by remote control. The vehicle 100 includes a vehicle control device 110 for controlling various units of the vehicle 100, an actuator group 120 including at least one actuator driven under the control of the vehicle control device 110, and a communication device 130 for communicating with the server device 200 via wireless communication. The actuator group 120 includes an actuator for a driving device for accelerating the vehicle 100, an actuator for a steering device for changing the traveling direction of the vehicle 100, and an actuator for a braking device for braking the vehicle 100. The driving device includes a battery, a driving motor driven by electric power of the battery, and wheels rotated by the driving motor. The driving motor is included in the actuator for the driving device.

The vehicle control device 110 includes a computer with a processor 111, a memory 112, an input/output interface 113, and an internal bus 114. The processor 111, the memory 112, and the input/output interface 113 are connected via the internal bus 114 to enable bidirectional communication. The actuator group 120 and the communication device 130 are connected to the input/output interface 113.

The processor 111 functions as a running control unit 115 by executing a computer program PG1 stored in advance in the memory 112. When the vehicle 100 has a driver, the running control unit 115 can cause the vehicle 100 to run by controlling the actuator group 120 in response to the operation by the driver. The running control unit 115 is capable of causing the vehicle 100 to run by controlling the actuator group 120 in response to running commands transmitted from the server device 200, regardless of whether the vehicle 100 has a driver. The running commands are used to control running of the vehicle 100 by unmanned driving. In the following description, a running command may also be referred to as a running control signal. In the present embodiment, the running control signal includes the acceleration and the steering angle of the vehicle 100 as parameters. In alternative embodiments, the running control signal may include the speed of the vehicle 100 as a parameter instead of, or in addition to, the acceleration of the vehicle 100.

The server device 200 is provided outside the vehicle 100. The server device 200 includes a computer with a processor 201, a memory 202, an input/output interface 203, and an internal bus 204. The processor 201, the memory 202, and the input/output interface 203 are connected via the internal bus 204 to enable bidirectional communication. The input/output interface 203 is connected to a communication device 205 for enabling communication with the vehicle 100 via wireless communication. In the present embodiment, the communication device 205 is capable of communication with the external sensors 300 and the assembly robots 400 via wired or wireless communication.

The processor 201 functions as a position information generation unit 211, a command generation unit 212, a command transmission unit 213, a stopping detection unit 214, a stopping unit 215, an assembly detection unit 216, and a restarting unit 217 by executing a computer program PG2 stored in advance in the memory 202. The position information generation unit 211 generates position information that indicates the current location of the vehicle 100. The command generation unit 212 generates a running command for causing the vehicle 100 to run using the position information generated by the position information generation unit 211. The command transmission unit 213 controls transmission of the running command generated by the command generation unit 212 to the vehicle 100.

The stopping detection unit 214 detects that the vehicle 100 has been stopped at an assembly position where parts are assembled onto the vehicle 100. The assembly position is a position where the vehicle 100 should be stopped while the parts are assembled onto the vehicle 100. In the present embodiment, the assembly position is located on the track TR. The stopping unit 215 stops at least one of the process of generating running commands by the command generation unit 212 and the process of transmitting the running commands by the command transmission unit 213 when the stopping detection unit 214 detects that the vehicle 100 has been stopped at the assembly position. In the present embodiment, the stopping unit 215 switches a stop flag to an ON state, thereby stopping at least one of the process of generating running commands by the command generation unit 212 and the process of transmitting the running commands by the command transmission unit 213. In the present embodiment, when the stop flag is in an OFF state, the process of generating running commands by the command generation unit 212 and the process of transmitting the running commands by the command transmission unit 213 are executed. When the stop flag is switched to the ON state, the process of generating running commands by the command generation unit 212 and the process of transmitting the running commands by the command transmission unit 213 are stopped.

The assembly detection unit 216 detects that the assembly of parts onto the vehicle 100 has been completed. The restarting unit 217 restarts the process or processes that have been stopped by the stopping unit 215, when the assembly detection unit 216 detects that the assembly of parts onto the vehicle 100 has been completed. In the present embodiment, the restarting unit 217 switches the stop flag to the OFF state, thereby restarting the process of generating running commands by the command generation unit 212 and the process of transmitting the running commands by the command transmission unit 213.

The external sensors 300 are located outside the vehicle 100. The external sensors 300 are used to detect the position and the orientation of the vehicle 100. In the present embodiment, the external sensors 300 are cameras provided in the factory FC. Each external sensor 300 includes a communication device (not shown), and is capable of communication with the server device 200 via wired or wireless communication.

The assembly robot 400 includes a robot control device 410, an arm unit 420, and a communication device 430. The robot control device 410 controls each unit of the assembly robot 400. In the present embodiment, the arm unit 420 is structured with a vertical articulated robot arm. The arm unit 420 is not limited to a vertical articulated robot arm, but may also be structured with, for example, a horizontal articulated robot arm, an orthogonal robot arm, or a parallel link robot arm. An end effector 425 for gripping parts is attached to the top end portion of the arm unit 420. In the following description, gripping a part by the end effector 425 is referred to as gripping a part by the arm unit 420. In the present embodiment, the end effector 425 is configured to pinch and grip a part. The end effector 425 may also be configured to suck and grip a part instead of pinching and gripping the part. In the present embodiment, the assembly robot 400 may also be referred to as an assembly device.

The robot control device 410 includes a computer with a processor 411, a memory 412, an input/output interface 413, and an internal bus 414. The processor 411, the memory 412, and the input/output interface 413 are connected via the internal bus 414 to enable bidirectional communication. The arm unit 420 and the communication device 430 are connected to the input/output interface 413.

The processor 411 functions as an arm control unit 415 by executing a computer program PG4 stored in advance in the memory 412. The arm control unit 415 controls the arm unit 420 to execute assembly of parts onto the vehicle 100.

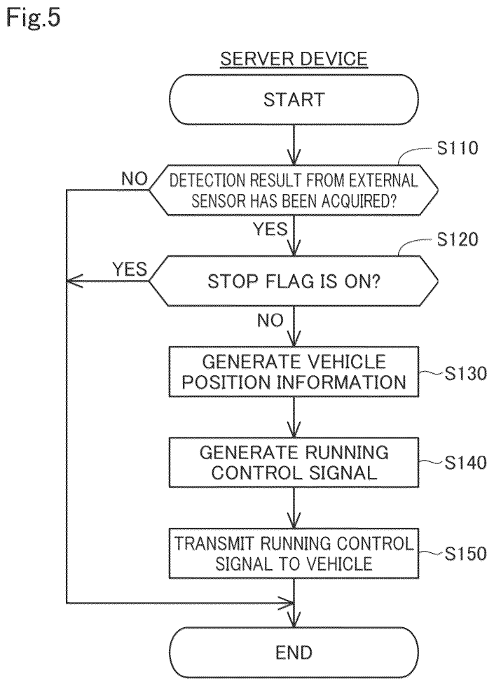

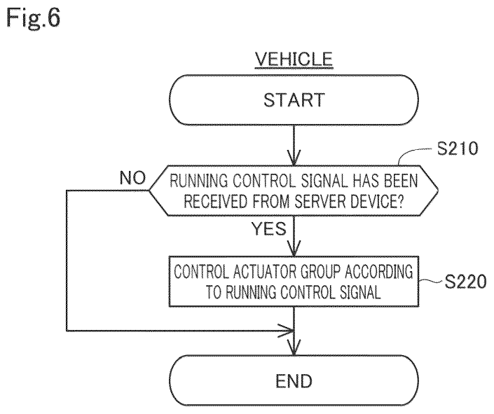

FIG. 5 is a first flowchart showing procedures in the process of running control of the vehicle 100 in the first embodiment. FIG. 6 is a second flowchart showing procedures in the process of running control of the vehicle 100 in the first embodiment. The process shown in FIG. 5 is repeated in a predetermined cycle by the processor 201 of the server device 200. The process shown in FIG. 6 is repeated in a predetermined cycle by the processor 111 of the vehicle control device 110 mounted on the vehicle 100.

As shown in FIG. 5, in the step S110, the position information generation unit 211 of the server device 200 determines whether the detection results of the external sensor 300 have been acquired. If it is not determined that the detection results of the external sensor 300 have been acquired, the position information generation unit 211 skips the processes from the step S110 onward. If it is determined that the detection results of the external sensor 300 have been acquired, the position information generation unit 211 proceeds to the process of the step S120.

In the step S120, the position information generation unit 211 determines whether the stop flag is in the ON state. If it is determined that the stop flag is in the ON state, the position information generation unit 211 skips the processes from the step S120 onward. If it is not determined that the stop flag is in the ON state, in other words, if it is determined that the stop flag is in the OFF state, the position information generation unit 211 proceeds to the process of the step S130.

In the step S130, the position information generation unit 211 generates vehicle position information using the detection results output from the external sensor 300. The vehicle position information is position information that serves as the base in generating the running control signals. In the present embodiment, the vehicle position information includes the position and orientation of the vehicle 100 in the global coordinate system GC of the factory FC. Specifically, in the step S130, the position information generation unit 211 generates the vehicle position information using a captured image acquired from a camera, which is the external sensor 300.

More specifically, in step S130, the position information generation unit 211 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system GC, thereby acquiring the location of the vehicle 100. The outer shape of the vehicle 100 in the captured image may be detected by inputting the captured image to a detection model DM using artificial intelligence, for example. The detection model DM is prepared in the system 10 or outside the system 10. The detection model DM is stored in advance in the memory 202 of the server device 200, for example. An example of the detection model DM is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 100 or a region indicating a subject other than the vehicle 100, for example. In training the CNN, a parameter for the CNN is preferably updated through backpropagation in such a manner as to reduce error between output result obtained by the detection model DM and the label. The position information generation unit 211 can acquire the orientation of the vehicle 100 through estimation based on the direction of a motion vector of the vehicle 100 detected from change in location of a feature point of the vehicle 100 between frames of the captured images using optical flow process, for example.

In the step S140, the command generation unit 212 first determines the target location to which the vehicle 100 should go next. In the present embodiment, the target location is expressed in the form of X, Y, Z coordinates in the global coordinate system GC. The memory 202 of the server device 200 stores in advance a reference route RR on which the vehicle 100 should run. The route is represented by a node indicating the departure point, a node indicating the transit point, a node indicating the destination, and a link connecting these nodes. The command generation unit 212 determines the target location to which the vehicle 100 should go next using the vehicle position information and the reference route RR. The command generation unit 212 determines the target location on the reference route RR ahead of the current location of the vehicle 100.

The command generation unit 212 then generates a running control signal to cause the vehicle 100 to run toward the determined target location. The command generation unit 212 calculates the running speed of the vehicle 100 based on the positional transition of the vehicle 100 and compares the calculated running speed with the target speed. When the running speed is generally lower than the target speed, the command generation unit 212 determines the acceleration so that the vehicle 100 increases its speed, and when the running speed is generally higher than the target speed, the command generation unit 212 determines the acceleration so that the vehicle 100 decreases its speed. Further, when the vehicle 100 is located on the reference route RR, the command generation unit 212 determines the steering angle and the acceleration so that the vehicle 100 does not deviate from the reference route RR. When the vehicle 100 is not located on the reference route RR, in other words, when the vehicle 100 deviates from the reference route RR, the command generation unit 212 determines the steering angle and the acceleration so that the vehicle 100 returns to the reference route RR.

In the step S150, the command transmission unit 213 transmits the generated running control signal to the vehicle 100. When the stop flag is in the OFF state, the server device 200 repeats the generation of the vehicle position information, the determination of the target location, the generation of the running control signal, the transmission of the running control signal, and the like, in a predetermined cycle.

As shown in FIG. 6, in the step S210, the running control unit 115 of the vehicle 100 determines whether the running control signal transmitted from the server device 200 has been received. If it is not determined that the running control signal has been received, the running control unit 115 skips the processes from the step S210 onward. If it is determined that the running control signal has been received, the running control unit 115 proceeds to the process of the step S220.

In the step S220, the running control unit 115 controls the actuator group 120 using the received running control signal, thereby causing the vehicle 100 to run at the acceleration and the steering angle indicated by the running control signal. The processor 111 repeats the reception of the running control signal and the control of the actuator group 120 in a predetermined cycle. The system 10 of the present embodiment enables the vehicle 100 to run by remote control, thereby moving the vehicle 100 without using transport equipment, such as a crane or a conveyor.

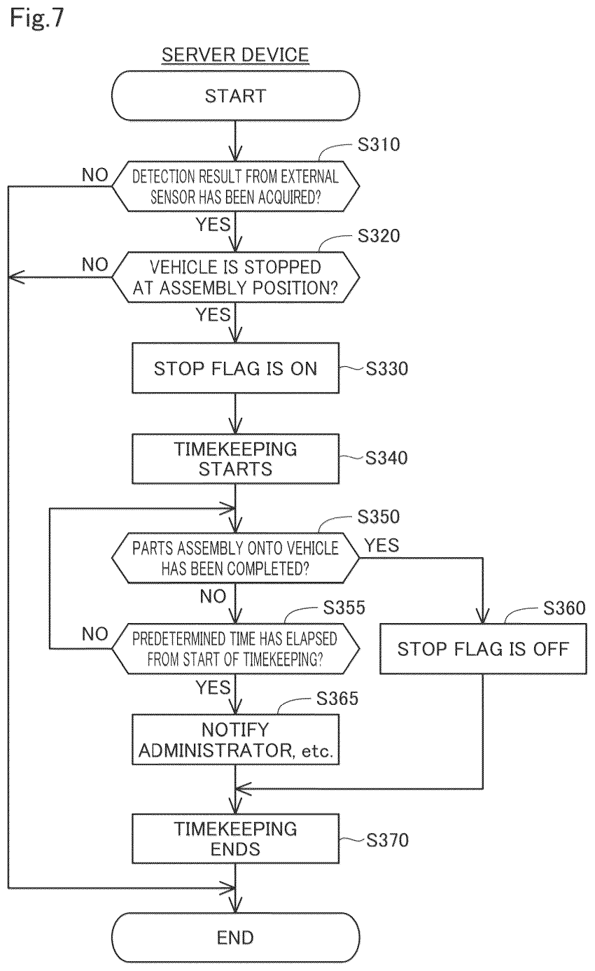

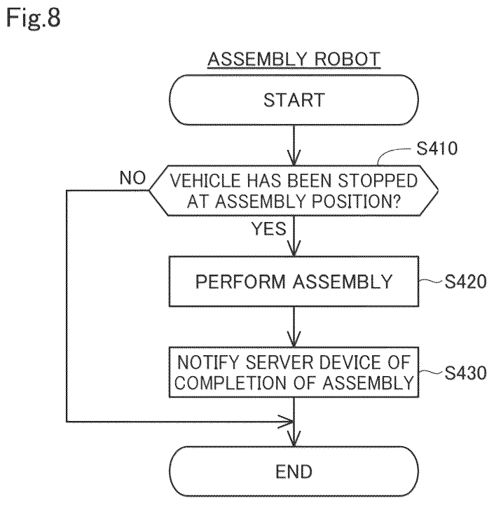

FIG. 7 is a first flowchart showing procedures in the process of stop flag switching control in the present embodiment. FIG. 8 is a second flowchart showing procedures in the process of stop flag switching control in the present embodiment. The process shown in FIG. 7 is repeated in a predetermined cycle by the processor 201 of the server device 200. The process shown in FIG. 8 is repeated in a predetermined cycle by the processor 411 of the robot control device 410.

As shown in FIG. 7, in the step S310, the stopping detection unit 214 of the server device 200 determines whether the detection results of the external sensor 300 has been acquired. If it is not determined that the detection results of the external sensor 300 have been acquired, the stopping detection unit 214 skips the processes from the step S310 onward. If it is determined that the detection results of the external sensor 300 have been acquired, the stopping detection unit 214 proceeds to the process of the step S320.

In the step S320, the stopping detection unit 214 determines whether the vehicle 100 is stopped at the assembly position using the detection results of the external sensor 300. If it is not determined that the vehicle 100 is stopped at the assembly position, the stopping detection unit 214 skips the processes from the step S320 onward. If it is determined that the vehicle 100 is stopped at the assembly position, the stopping detection unit 214 proceeds to the process of the step S330. In the present embodiment, the stopping detection unit 214 determining that the vehicle 100 is stopped at the assembly position using predetermined information may also be referred to as the stopping detection unit 214 detecting that the vehicle 100 is stopped at the assembly position.

In the step S330, the stopping unit 215 sets the stop flag to the ON state. In the step S340, the assembly detection unit 216 starts timekeeping. In the step S350, the assembly detection unit 216 determines whether the assembly of a part onto the vehicle 100 that has been stopped at the assembly position has been completed.

In the step S350, the assembly detection unit 216 can determine whether the assembly of the part onto the vehicle 100 has been completed using, for example, at least one of the following methods A to F. In the present embodiment, the assembly detection unit 216 determining that the assembly of the part onto the vehicle 100 has been completed using the predetermined information may also be referred to as the assembly detection unit 216 detecting that the assembly of the part onto the vehicle 100 has been completed.

### Method A

In a method A, the assembly detection unit 216 determines whether the assembly of a part onto the vehicle 100 has been completed using information acquired from the assembly robot 400 that assembles parts onto the vehicle 100. Information regarding the state of the arm unit 420 is transmitted from the assembly robot 400 to the server device 200. In this method, the information regarding the state of the arm unit 420 includes information regarding the position and orientation of the arm unit 420. The assembly detection unit 216 determines that the assembly of the part onto the vehicle 100 has been completed when the information regarding the state of the arm unit 420 indicates that the arm unit 420 has retracted to a predetermined retracted position. The retracted position is provided in a location sufficiently distant from the vehicle 100 that has been stopped at the assembly position. This method prevents the vehicle 100 that has started running from the assembly position from coming into contact with the arm unit 420.

### Method B

In a method B, the assembly detection unit 216 determines whether the assembly of a part onto the vehicle 100 has been completed using information acquired from the assembly robot 400 that assembles parts onto the vehicle 100. Information regarding the state of the arm unit 420 is transmitted from the assembly robot 400 to the server device 200. In this method, the information regarding the state of the arm unit 420 includes information regarding whether the arm unit 420 is gripping a part. The assembly detection unit 216 can determine that the assembly of a part is completed when the arm unit 420 releases the part.

### Method C

In a method C, the assembly detection unit 216 determines whether the assembly of a part onto the vehicle 100 has been completed using information acquired from the external sensor 300. The assembly detection unit 216 can determine whether the assembly of the part by the arm unit 420 has been completed by analyzing an image acquired from the camera, which is the external sensor 300. This method allows the assembly detection unit 216 to determine whether the assembly of a part has been completed also when the part is assembled by a worker instead of the assembly robot 400.

### Method D

In a method D, the assembly detection unit 216 determines whether the assembly of a part onto the vehicle 100 has been completed using a pass/fail determination result with regard to the assembly of the part onto the vehicle 100. The assembly detection unit 216 determines whether the assembly of a part onto the vehicle 100 is acceptable (pass) or unacceptable (fail) by an image test using an image acquired from the camera, which is the external sensor 300. The assembly detection unit 216 determines that the assembly of the part onto the vehicle 100 has been completed when the pass/fail determination result with regard to the assembly is obtained. This method allows the assembly detection unit 216 to determine whether the assembly of a part has been completed also when the part is assembled by a worker instead of the assembly robot 400. Further, if the pass/fail determination result indicates “acceptable”, the assembly detection unit 216 restarts the running of the vehicle 100 and then generates the running control signal to move the vehicle 100 to the second place PL2 shown in FIG. 1. If the pass/fail determination result indicates “unacceptable”, the assembly detection unit 216 restarts the running of the vehicle 100 and then may generate the running control signal to move the vehicle 100 to a repair place (not shown), instead of the second place PL2. In this case, the vehicle 100 can be automatically moved to the repair place, and the failure in the assembly of the part can be addressed at the repair place.

### Method E

In a method E, the assembly detection unit 216 determines whether the assembly of a part onto the vehicle 100 has been completed using information acquired from the vehicle 100. In an embodiment in which the part to be assembled onto the vehicle 100 is an electronic device to be connected to the vehicle control device 110 and a result of confirmation of the communication capability between the vehicle control device 110 and the part is transmitted from the vehicle control device 110 to the server device 200 after the part is assembled onto the vehicle 100, the assembly detection unit 216 can determine that the assembly of the part onto the vehicle 100 is completed when the result of confirmation of the communication capability is received from the vehicle 100. This method allows the assembly detection unit 216 to determine whether the assembly of a part has been completed also when the part is assembled by a worker instead of the assembly robot 400.

### Method F

In a method F, the assembly detection unit 216 determines that the assembly of a part onto the vehicle 100 has been completed when a button provided in the factory FC is pressed by a worker. This method allows the assembly detection unit 216 to determine whether the assembly of a part has been completed also when the part is assembled by a worker instead of the assembly robot 400.

In the present embodiment, the method A or the method B is used in the step of assembling the part onto the vehicle 100 by the assembly robot 400. The method C or the method D may be used in the step of assembling the part onto the vehicle 100 by a small-sized assembly robot 400. The method D is used in the step of assembling an electronic part onto the vehicle 100.

If it is determined in the step S350 that the assembly of the part has been completed, the assembly detection unit 216 proceeds to the process of the step S360. In the step S360, the restarting unit 217 sets the stop flag to the OFF state. In the step S370, the assembly detection unit 216 ends the timekeeping.

If it is not determined in the step S350 that the assembly of the part has been completed, the assembly detection unit 216 proceeds to the process of the step S355. In the step S355, the assembly detection unit 216 determines whether a predetermined time has elapsed from the start of timekeeping. If it is not determined that the predetermined time has elapsed from the start of timekeeping, the assembly detection unit 216 returns to the process of the step S350 and determines again whether the assembly of the part onto the vehicle 100 that has been stopped at the assembly position has been completed. If it is determined that the predetermined time has elapsed from the start of timekeeping, in the step S365, the assembly detection unit 216 notifies the administrator of the system 10 or workers in the factory FC that an abnormality has occurred. In the following description, the administrator of the system 10 and the workers in the factory FC are referred to as “administrator and the like”. The assembly detection unit 216 notifies the administrator and the like that an abnormality has occurred, for example, by transmitting a message to a mobile terminal carried by the administrator and the like. The assembly detection unit 216 may also notify that an abnormality has occurred by activating a warning buzzer or a warning lamp provided in the factory FC. Then, in the step S370, the assembly detection unit 216 ends the timekeeping.

As shown in FIG. 8, in the step S410, the arm control unit 415 of the assembly robot 400 determines whether the vehicle 100 has been stopped at the assembly position. If it is not determined in the step S410 that the vehicle 100 has been stopped at the assembly position, the arm control unit 415 skips the processes after the step S410. If it is determined in the step S410 that the vehicle 100 has been stopped at the assembly position, the arm control unit 415 executes assembly of the part onto the vehicle 100 in the step S420. After the assembly of the part by the arm unit 420 is completed, in the step S430, the arm control unit 415 notifies the server device 200 that the assembly of the parts is completed. In the present embodiment, the arm control unit 415 notifies the server device 200 that the assembly of the part is completed by transmitting information regarding the position and orientation of the arm unit 420 to the server device 200 after the arm unit 420 releases the part and then is retracted to the predetermined retracted position.

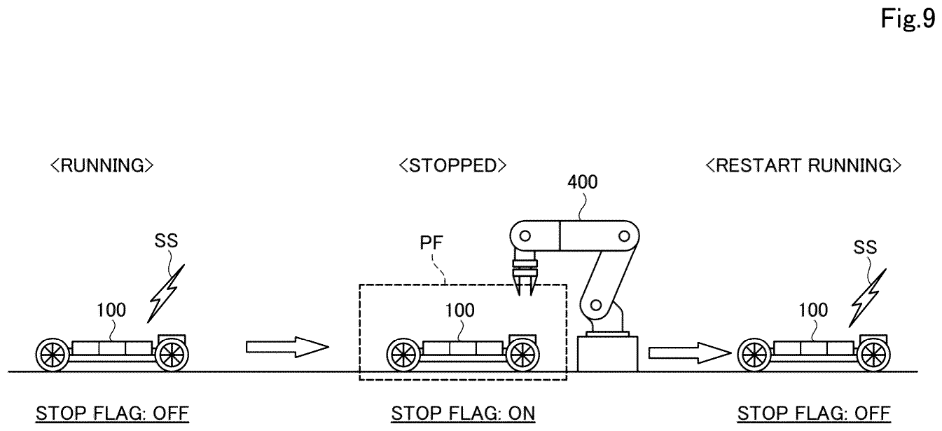

FIG. 9 is an explanatory view showing a state in which a part is assembled onto the vehicle 100. By the control method for the vehicle 100 mentioned above, the stop flag stays in the OFF state until the vehicle 100 stops at an assembly position PF; therefore, the generation and transmission of a running control signal SS by the server device 200 are executed. This allows the vehicle 100 to run to the assembly position PF using the running control signal SS received from the server device 200.

When the vehicle 100 stops at the assembly position PF, the stop flag is switched to the ON state until the assembly of the part onto the vehicle 100 is completed. Therefore, the generation of the running control signal SS by the server device 200 is stopped, and accordingly, the transmission of the running control signal SS from the server device 200 to the vehicle 100 is also stopped. This prevents the vehicle 100 from starting the running during the assembly of the part onto the vehicle 100. Therefore, the assembly robot 400 can be prevented from being dragged by the vehicle 100. A signal indicating that the assembly is in progress may be transmitted from the assembly robot 400 to the vehicle 100 to prevent misunderstanding that an error has occurred in the vehicle 100 waiting to receive the running control signal SS.

The stop flag is switched to the OFF state when the assembly of the part onto the vehicle 100 is completed. Therefore, the generation and transmission of the running control signal SS by the server device 200 are restarted. This allows the vehicle 100 to run toward the next destination using the running control signal SS received from the server device 200.

According to the server device 200 in the present embodiment described above, when it is detected that the vehicle 100 has been stopped at the assembly position PF, the stopping unit 215 sets the stop flag to the ON state, thereby stopping the generation of running control signals by the command generation unit 212 and transmission of running control signals by the command transmission unit 213. This prevents the vehicle 100 from restarting the running by unmanned driving during the assembly of the part onto the vehicle 100. This prevents failure in parts assembly, and prevents the assembly robot 400 from being dragged by the vehicle 100. Further, when the stop flag is set to the ON state, the generation of running control signals is stopped, thereby reducing the processing load on the processor 201 during the assembly of parts onto the vehicle 100.

Further, in the present embodiment, when it is detected that the assembly of the part onto the vehicle 100 has been completed, the restarting unit 217 sets the stop flag to the OFF state, thereby restarting the generation of running control signals by the command generation unit 212 and transmission of running control signals by the command transmission unit 213. This allows the vehicle 100 to restart the running by unmanned driving after the assembly of the part onto the vehicle 100 is completed.

### B. Second Embodiment

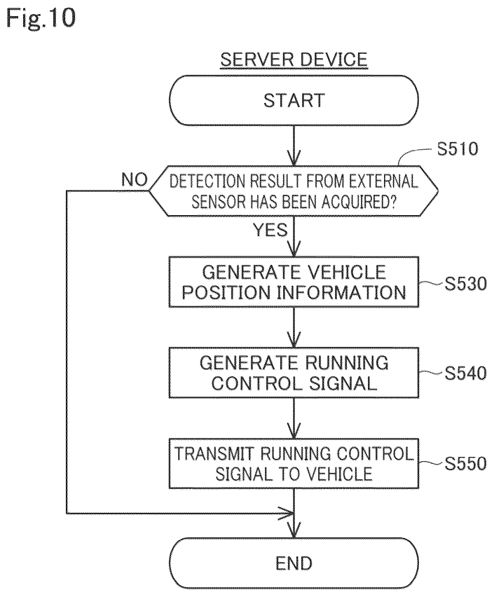

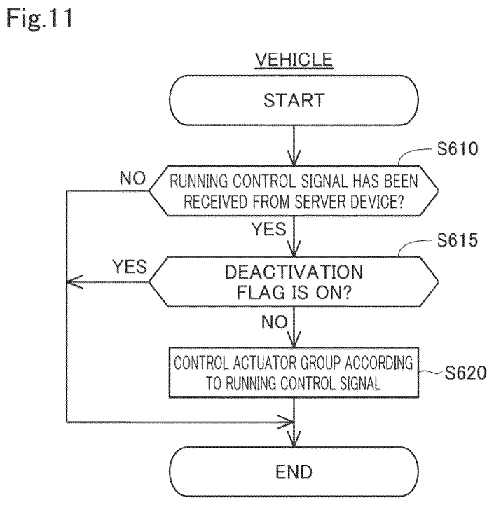

FIG. 10 is a first flowchart showing procedures in the process of running control of the vehicle 100 in the second embodiment. FIG. 11 is a second flowchart showing procedures in the process of running control of the vehicle 100 in the second embodiment. The second embodiment differs from the first embodiment in that, when it is detected that the vehicle 100 has been stopped at the assembly position, the stopping unit 215 does not perform the process of stopping the generation of the running command by the command generation unit 212 or the process of stopping the transmission of the running command by the command transmission unit 213, but performs a process of transmitting to the vehicle 100 a deactivation command that disables the running command. Other structures are the same as those in the first embodiment, unless otherwise specified.

In the present embodiment, a deactivation flag is set in the vehicle control device 110. The deactivation flag is used to switch between activation and deactivation of the process of driving the actuator group 120 using the running control signal received from the server device 200. When the deactivation flag is in the OFF state, the running control unit 115 drives the actuator group 120 using the running control signal received from the server device 200, and, when the deactivation flag is in the ON state, the running control unit 115 does not drive the actuator group 120 using the running control signal received from the server device 200.

The process shown in FIG. 10 is repeated in a predetermined cycle by the processor 201 of the server device 200. The process shown in FIG. 11 is repeated in a predetermined cycle by the processor 111 of the vehicle control device 110 mounted on the vehicle 100.

As shown in FIG. 10, in the step S510, the position information generation unit 211 determines whether the detection results of the external sensor 300 have been acquired. If it is not determined that the detection results of the external sensor 300 have been acquired, the position information generation unit 211 skips the processes from the step S510 onward. If it is determined that the detection results of the external sensor 300 have been acquired, in the step S530, the position information generation unit 211 generates vehicle position information using the detection results output from the external sensor 300. In the step S540, the command generation unit 212 determines the target location to which the vehicle 100 should go next and generates a running control signal for causing the vehicle 100 to run toward the determined target location. In the step S550, the command transmission unit 213 transmits the generated running control signal to the vehicle 100.

As shown in FIG. 11, in the step S610, the running control unit 115 of the vehicle 100 determines whether the running control signal transmitted from the server device 200 has been received. If it is not determined that the running control signal has been received, the running control unit 115 skips the processes from the step S610 onward. If it is determined that the running control signal has been received, in the step S615, the running control unit 115 determines whether the deactivation flag is in the ON state. If it is determined that the deactivation flag is in the ON state, the running control unit 115 skips the processes from the step S615 onward. If it is determined that the deactivation flag is not in the ON state, in other words, the deactivation flag is in the OFF state, in the step S620, the running control unit 115 controls the actuator group 120 using the received running control signal, thereby causing the vehicle 100 to run at the acceleration and the steering angle indicated by the running control signal.

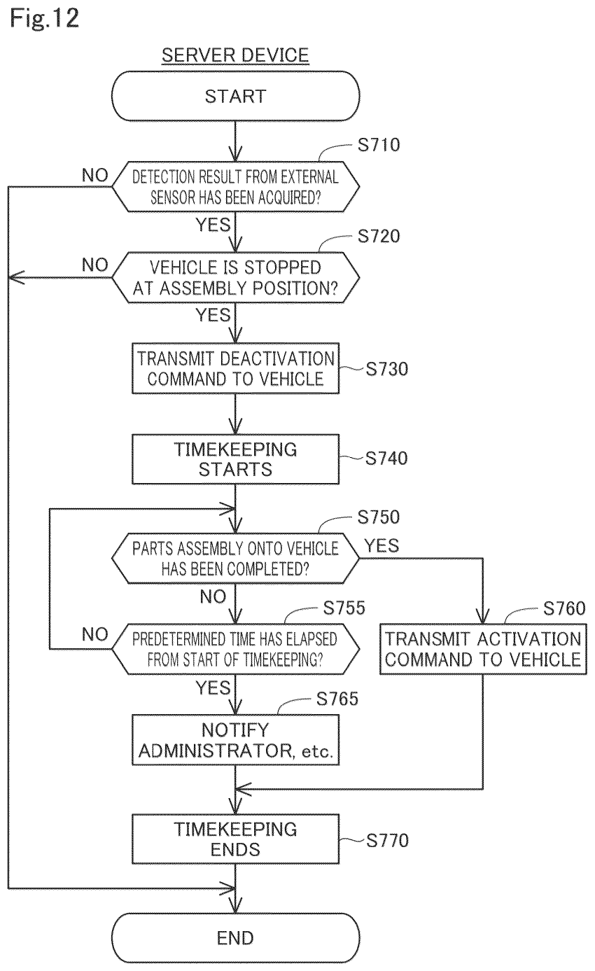

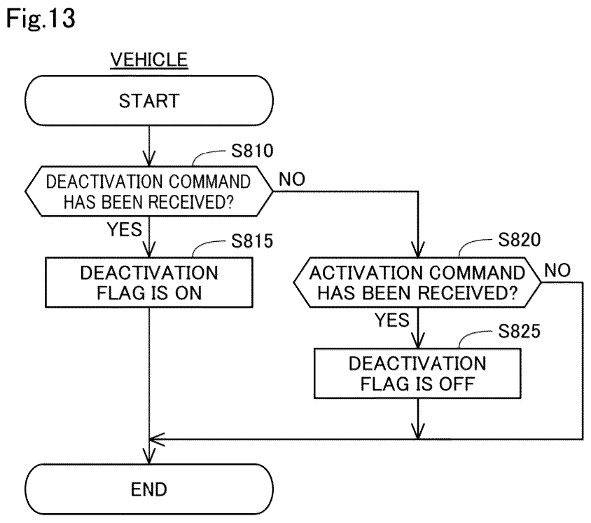

FIG. 12 is a first flowchart showing procedures in the process of deactivation flag switching control in the second embodiment. FIG. 13 is a second flowchart showing procedures in the process of deactivation flag switching control in the second embodiment. The process shown in FIG. 12 is repeated in a predetermined cycle by the processor 201 of the server device 200. The process shown in FIG. 13 is repeated in a predetermined cycle by the processor 111 of the vehicle control device 110.

As shown in FIG. 12, in the step S710, the stopping detection unit 214 determines whether the detection results of the external sensor 300 have been acquired. If it is not determined that the detection results of the external sensor 300 have been acquired, the stopping detection unit 214 skips the processes from the step S710 onward. If it is determined that the detection results of the external sensor 300 have been acquired, in the step S720, the stopping detection unit 214 determines whether the vehicle 100 is stopped at the assembly position using the detection results of the external sensor 300. If it is not determined that the vehicle 100 is stopped at the assembly position, the stopping detection unit 214 skips the processes from the step S720 onward. If it is determined that the vehicle 100 is stopped at the assembly position, the stopping detection unit 214 proceeds to the process of the step S730.

In the step S730, the stopping unit 215 transmits to the vehicle 100 a deactivation command that sets the deactivation flag to the ON state. In the step S740, the assembly detection unit 216 starts timekeeping. In the step S750, the assembly detection unit 216 determines whether the assembly of a part onto the vehicle 100 that has been stopped at the assembly position has been completed. If it is determined in the step S750 that the assembly of the part has been completed, in the step S760, the restarting unit 217 transmits to the vehicle 100 an activation command that sets the deactivation flag to the OFF state. Then, in the step S770, the assembly detection unit 216 ends the timekeeping.

If it is not determined in the step S750 that the assembly of the part has been completed, in the step S755, the assembly detection unit 216 determines whether a predetermined time has elapsed from the start of timekeeping. If it is not determined that the predetermined time has elapsed from the start of timekeeping, the assembly detection unit 216 returns to the process of the step S750 and determines again whether the assembly of the part has been completed. If it is determined that the predetermined time has elapsed from the start of timekeeping, in the step S765, the assembly detection unit 216 notifies the administrator and the like that an abnormality has occurred, and then ends the timekeeping in the step S770.

As shown in FIG. 13, in the step S810, the running control unit 115 of the vehicle 100 determines whether the deactivation command has been received. If it is determined that the deactivation command has been received, the running control unit 115 sets the deactivation flag to the ON state in the step S815. If it is not determined that the deactivation command has been received, in the step S820, the running control unit 115 determines whether the activation command has been received. If it is determined that the activation command has been received, the running control unit 115 sets the deactivation flag to the OFF state in the step S825. If it is not determined that the activation command has been received, the running control unit 115 skips the process of the step S825.

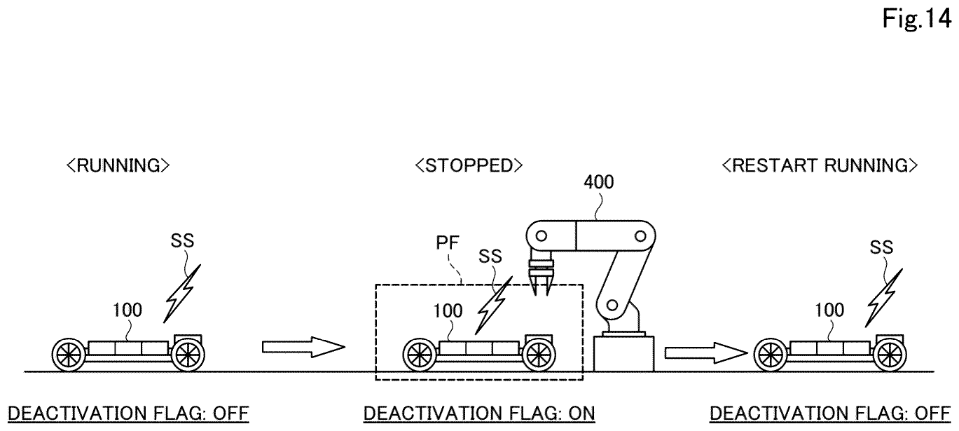

FIG. 14 is an explanatory view showing a state in which a part is assembled onto the vehicle 100 in the second embodiment. Since the deactivation flag is in the OFF state until the vehicle 100 stops at the assembly position PF, the vehicle control device 110 causes the vehicle 100 to run by driving the actuator group 120 using the running control signal SS received from the server device 200.

When the vehicle 100 stops at the assembly position PF, the deactivation flag is switched to the ON state until the assembly of the part onto the vehicle 100 is completed. Therefore, the transmission of the running control signal SS from the server device 200 continues; however, the vehicle control device 110 does not drive the actuator group 120 using the running control signal SS. Therefore, the vehicle 100 remains stationary until the assembly of the part is completed.

When the assembly of the part onto the vehicle 100 is completed, the deactivation flag is switched to the OFF state; accordingly, the vehicle control device 110 restarts the running of the vehicle 100 by driving the actuator group 120 using the running control signal SS received from the server device 200.

According to the server device 200 in the present embodiment described above, the stopping unit 215 sets the deactivation flag of the vehicle control device 110 to the ON state when it is detected that the vehicle 100 has been stopped at the assembly position PF. This prevents the vehicle 100 from restarting the running by unmanned driving during the assembly of the part onto the vehicle 100. Further, in the present embodiment, the restarting unit 217 sets the deactivation flag of the vehicle control device 110 to the OFF state when it is detected that the assembly of a part onto the vehicle 100 has been completed. This allows the vehicle 100 to restart the running by unmanned driving after the assembly of the part onto the vehicle 100 is completed.

The first embodiment and the second embodiment may be combined. Specifically, the stopping unit 215 may set the stop flag of the server device 200 to the ON state and also set the deactivation flag of the vehicle control device 110 to the ON state when it is detected that the vehicle 100 has been stopped at the assembly position PF. In this case, it is possible to more reliably prevent the vehicle 100 from restarting the running by unmanned driving during the assembly of the part onto the vehicle 100. Further, the restarting unit 217 may also set the stop flag of the server device 200 to the OFF state and set the deactivation flag of the vehicle control device 110 to the OFF state when it is detected that the assembly of a part onto the vehicle 100 has been completed. In this case, it is possible to restart the running of the vehicle 100 by unmanned driving after the assembly of the part onto the vehicle 100 is completed.

### C. Third Embodiment

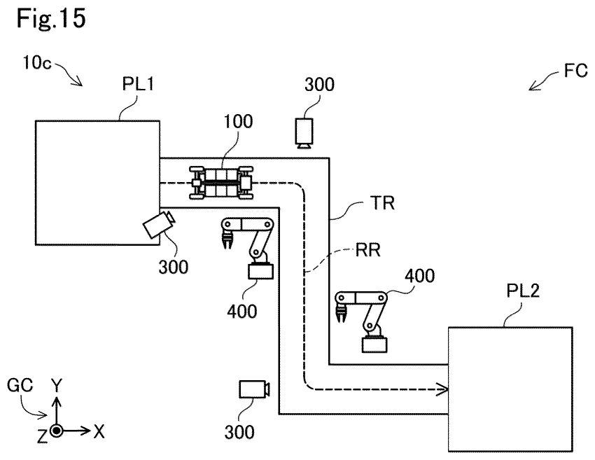

FIG. 15 is an explanatory view showing a structure of a system 10c according to a third embodiment. The third embodiment differs from the first embodiment in that the system 10c does not include the server device 200. Other structures are the same as those in the first embodiment, unless otherwise specified.

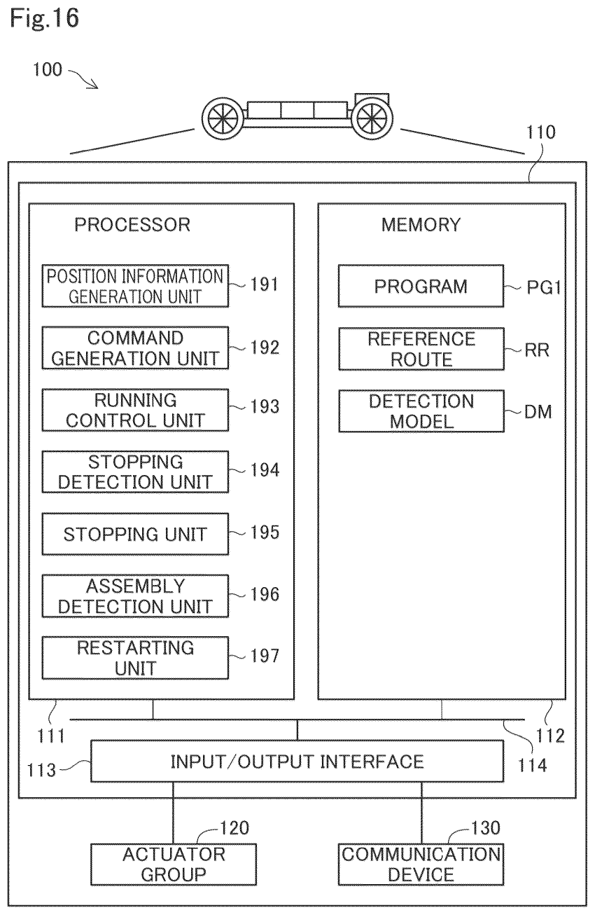

FIG. 16 is an explanatory view showing a structure of a vehicle 100 according to the third embodiment. In the present embodiment, the vehicle 100 is structured to be capable of running by autonomous control. In the present embodiment, the processor 111 of the vehicle control device 110 functions as a position information generation unit 191, a command generation unit 192, a running control unit 193, a stopping detection unit 194, a stopping unit 195, an assembly detection unit 196, and a restarting unit 197 by executing a computer program PG1 stored in advance in the memory 112. The position information generation unit 191 generates vehicle position information of the own vehicle. The command generation unit 192 generates a running command for driving the actuator group 120. The running control unit 193 causes the own vehicle to run by driving the actuator group 120 using the running command. The stopping detection unit 194 detects that the own vehicle has been stopped at the assembly position. The stopping unit 195 stops at least one of the process of generating a running command by the command generation unit 192 and the process of driving the actuator group 120 by the running control unit 193 using the running command when the stopping detection unit 194 detects that the own vehicle has been stopped at the assembly position. The assembly detection unit 196 detects that the assembly of parts onto the own vehicle has been completed. The restarting unit 197 restarts the process that has been stopped by the stopping unit 195, when the assembly detection unit 196 detects that the assembly of parts onto the own vehicle has been completed. A reference route RR and a detection model DM are stored in the memory 112 in advance.

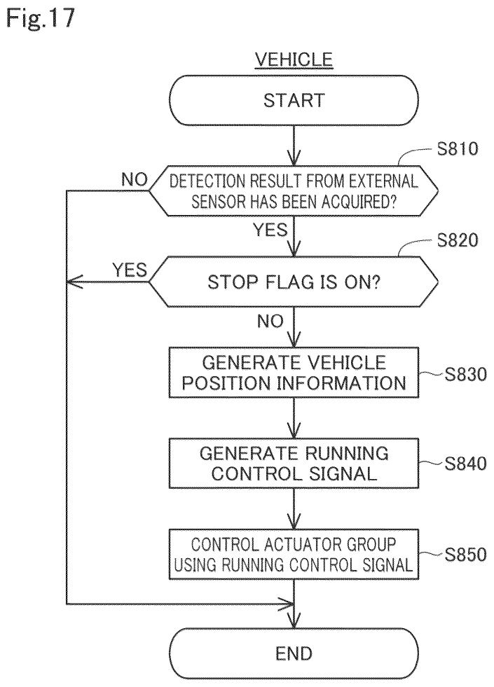

FIG. 17 is a first flowchart showing procedures in the process of running control of the vehicle 100 in the third embodiment. The process shown in FIG. 17 is repeated in a predetermined cycle by the processor 111 of the vehicle control device 110. In the step S810, the position information generation unit 191 determines whether the detection results of the external sensor 300 have been acquired. If it is not determined that the detection results of the external sensor 300 have been acquired, the position information generation unit 191 skips the processes from the step S810 onward. If it is determined that the detection results of the external sensor 300 have been acquired, the position information generation unit 191 proceeds to the process of the step S820.

In the step S820, the position information generation unit 191 determines whether the stop flag is in the ON state. If it is determined that the stop flag is in the ON state, the position information generation unit 191 skips the processes from the step S820 onward. If it is not determined that the stop flag is in the ON state, in other words, if it is determined that the stop flag is in the OFF state, the position information generation unit 191 proceeds to the process of the step S830.

In the step S830, the position information generation unit 191 generates vehicle position information using the detection results output from the external sensor 300. In the step S840, the command generation unit 192 determines the target location to which the vehicle 100 should go next and generates a running control signal for causing the vehicle 100 to run toward the determined target location. In the step S850, the running control unit 193 controls the actuator group 120 using the generated running control signal, thereby causing the vehicle 100 to run.

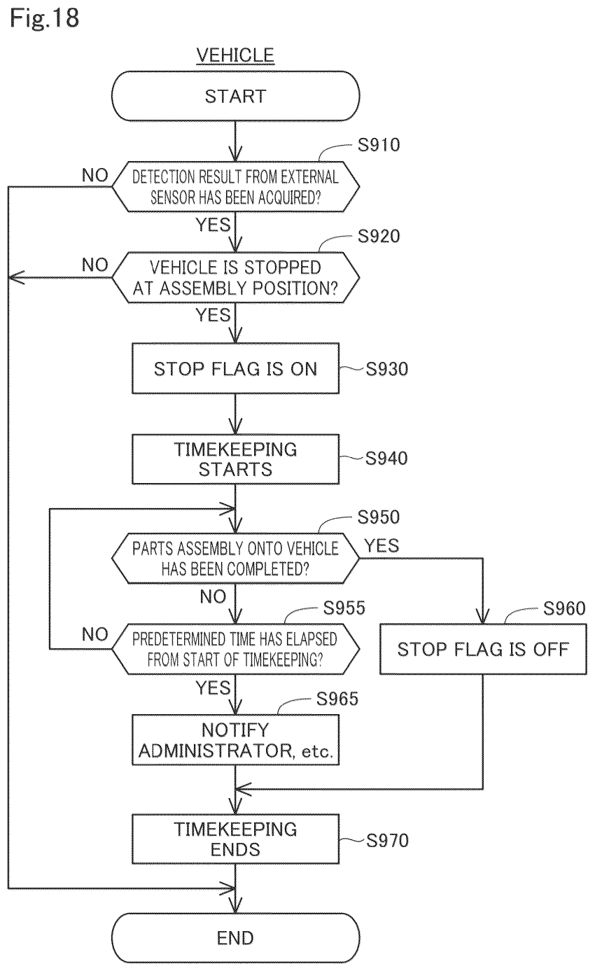

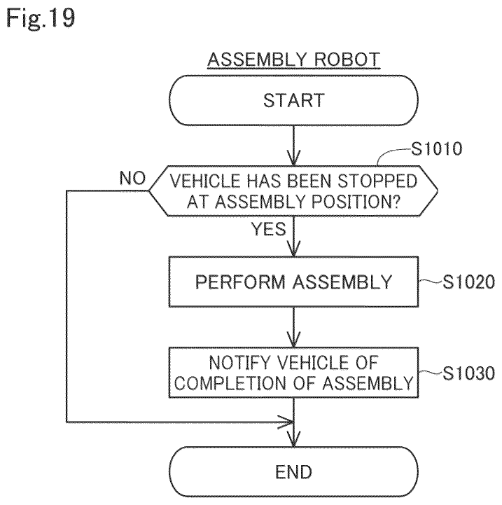

FIG. 18 is a first flowchart showing procedures in the process of stop flag switching in the third embodiment. FIG. 19 is a second flowchart showing procedures in the process of stop flag switching control in the third embodiment. The process shown in FIG. 18 is repeated in a predetermined cycle by the processor 111 of the vehicle control device 110. The process shown in FIG. 19 is repeated in a predetermined cycle by the processor 411 of the robot control device 410.

As shown in FIG. 18, in the step S910, the stopping detection unit 194 determines whether the detection results of the external sensor 300 have been acquired. If it is not determined that the detection results of the external sensor 300 have been acquired, the stopping detection unit 194 skips the processes from the step S910 onward. If it is determined that the detection results of the external sensor 300 have been acquired, the stopping detection unit 194 proceeds to the process of the step S920.

In the step S920, the stopping detection unit 194 determines whether the vehicle 100 is stopped at the assembly position using the detection results of the external sensor 300. If it is not determined that the vehicle 100 is stopped at the assembly position, the stopping detection unit 194 skips the processes from the step S920 onward. If it is determined that the vehicle 100 is stopped at the assembly position, the stopping detection unit 194 proceeds to the process of the step S930. In the present embodiment, the stopping detection unit 194 determining that the vehicle 100 is stopped at the assembly position using predetermined information may also be referred to as the stopping detection unit 194 detecting that the vehicle 100 is stopped at the assembly position.

In the step S930, the stopping unit 195 sets the stop flag to the ON state. In the step S940, the assembly detection unit 196 starts timekeeping. In the step S950, the assembly detection unit 196 determines whether the assembly of a part onto the vehicle 100 that has been stopped at the assembly position has been completed. If it is determined in the step S950 that the assembly of the part onto the vehicle 100 has been completed, the assembly detection unit 196 proceeds to the process of the step S960. In the step S960, the restarting unit 197 sets the stop flag to the OFF state. In the step S970, the assembly detection unit 196 ends the timekeeping. In the present embodiment, the assembly detection unit 196 determining that the assembly of the part onto the vehicle 100 has been completed using the predetermined information may also be referred to as the assembly detection unit 196 detecting that the assembly of the part onto the vehicle 100 has been completed.

If it is not determined in the step S950 that the assembly of the part onto the vehicle 100 has been completed, the assembly detection unit 196 proceeds to the process of the step S955. In the step S955, the assembly detection unit 196 determines whether a predetermined time has elapsed from the start of timekeeping. If it is not determined that the predetermined time has elapsed from the start of timekeeping, the assembly detection unit 196 returns to the process of the step S950 and determines again whether the assembly of the part onto the vehicle 100 has been completed. If it is determined that the predetermined time has elapsed from the start of timekeeping, in the step S965, the assembly detection unit 196 notifies the administrator and the like that an abnormality has occurred, and then ends the timekeeping in the step S970.

As shown in FIG. 19, in the step S1010, the arm control unit 415 of the assembly robot 400 determines whether the vehicle 100 has been stopped at the assembly position. If it is not determined that the vehicle 100 has been stopped at the assembly position, the arm control unit 415 skips the processes after the step S1010. If it is determined that the vehicle 100 has been stopped at the assembly position, the arm control unit 415 executes assembly of the part onto the vehicle 100 in the step S1020. In the step S1030, the arm control unit 415 notifies the vehicle 100 that the assembly has been completed.

According to the system 10c of the present embodiment described above, it is possible to prevent the vehicle 100 from restarting the running by unmanned driving during the assembly of the part onto the vehicle 100. In particular, in the present embodiment, it is possible to cause the vehicle 100 to move by autonomous control of the vehicle 100, instead of remote control by the server device 200.

### D. Alternative Embodiments

(D1) In the first and second embodiments described above, the server device 200 includes the assembly detection unit 216 and the restarting unit 217. In the third embodiment described above, the vehicle control device 110 includes the assembly detection unit 196 and the restarting unit 197. Optionally, the server device 200 and the vehicle control device 110 may not include the assembly detection units 216, 196 and the restarting units 217, 197. In this case, the vehicle 100 may be moved to the assembly position by unmanned driving, and, from the assembly position, the vehicle 100 may be moved by a transport device, such as a conveyor.

(D2) In the first embodiment described above, when the stop flag is in the ON state, the server device 200 stops the generation of position information of the vehicle 100, the generation of the running control signal, and the transmission of the running control signal. Optionally, when the stop flag is in the ON state, the server device 200 may continue the generation of position information of the vehicle 100 while stopping the generation of the running control signal and the transmission of the running control signal. In this case, the position information of the vehicle 100 can be used for purposes other than the running of the vehicle 100.

(D3) In the first to third embodiments described above, the external sensor 300 is not limited to the camera but may be the distance measuring device, for example. The distance measuring device is a light detection and ranging (LiDAR) device, for example. In this case, detection result output from the external sensor 300 may be three-dimensional point cloud data representing the vehicle 100. The server device 200 and the vehicle control device 110 may acquire the vehicle location information through template matching using the three-dimensional point cloud data as the detection result and reference point cloud data, for example.

(D4) In the first and second embodiments described above, the server device 200 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.

(1) The server device 200 may acquire vehicle location information, determine a target location to which the vehicle 100 is to move next, and generate a route from a current location of the vehicle 100 indicated by the acquired vehicle location information to the target location. The server device 200 may generate a route to the target location between the current location and a destination or generate a route to the destination. The server device 200 may transmit the generated route to the vehicle 100. The vehicle 100 may generate a running control signal in such a manner as to cause the vehicle 100 to run along the route received from the server device 200 and control the actuator group 120 using the generated running control signal.

(2) The server device 200 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control the actuator group 120 using the generated running control signal.

(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. More specifically, the internal sensor might include a camera, LiDAR, a millimeter wave radar, an ultrasonic wave sensor, a GPS sensor, an acceleration sensor, and a gyroscopic sensor, for example. For example, in the foregoing embodiment (1), the server device 200 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.

(D5) In the third embodiment described above, the vehicle 100 may be equipped with an internal sensor, and detection result output from the internal sensor may be used in at least one of generation of a route and generation of a running control signal. For example, the vehicle 100 may acquire detection result from the internal sensor, and in generating the route, may reflect the detection result from the internal sensor in the route. The vehicle 100 may acquire detection result from the internal sensor, and in generating the running control signal, may reflect the detection result from the internal sensor in the running control signal.

(D6) In the third embodiment described above, the vehicle 100 acquires vehicle location information using detection result from the external sensor. By contrast, the vehicle 100 may be equipped with an internal sensor, the vehicle 100 may acquire vehicle location information using detection result from the internal sensor, determine a target location to which the vehicle 100 is to move next, generate a route from a current location of the vehicle 100 indicated by the acquired vehicle location information to the target location, generate a running control signal for running along the generated route, and control the actuator group 120 of the vehicle 100 using the generated running control signal. In this case, the vehicle 100 is capable of running without using any detection result from an external sensor. The vehicle 100 may acquire target arrival time or traffic congestion information from outside the vehicle 100 and reflect the target arrival time or traffic congestion information in at least one of the route and the running control signal.

(D7) In the first and second embodiments described above, the server device 200 automatically generates a running control signal to be transmitted to the vehicle 100. By contrast, the server device 200 may generate a running control signal to be transmitted to the vehicle 100 in response to operation by an external operator existing outside the vehicle 100. For example, the external operator may operate an operating device including a display on which a captured image output from the external sensor 300 is displayed, steering, an accelerator pedal, and a brake pedal for operating the vehicle 100 remotely, and a communication device for making communication with the server device 200 through wire communication or wireless communication, for example, and the server device 200 may generate a running control signal responsive to the operation on the operating device.

(D8) In each of the above-described embodiments, the vehicle 100 is simply required to have a configuration to become movable by unmanned driving. The vehicle 100 may embodied as a platform having the following configuration, for example. The vehicle 100 is simply required to include at least actuators and a controller. More specifically, in order to fulfill three functions including “run,” “turn,” and “stop” by unmanned driving, the actuators may include a driving device, a steering device and a braking device. The actuators are controlled by the controller that controls running of the vehicle 100. In order for the vehicle 100 to acquire information from outside for unmanned driving, the vehicle 100 is simply required to include the communication device further. Specifically, the vehicle 100 to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 100 before the vehicle 100 is shipped from a factory, or a remaining component such as a bodyshell may be mounted on the vehicle 100 after the vehicle 100 is shipped from a factory while the remaining component such as a bodyshell is not mounted on the vehicle 100. Each of components may be mounted on the vehicle 100 from any direction such as from above, from below, from the front, from the back, from the right, or from the left. Alternatively, these components may be mounted from the same direction or from respective different directions. The location determination for the platform may be performed in the same way as for the vehicle 100 in the first embodiments.

(D9) The vehicle 100 may be manufactured by combining a plurality of modules. The module means a unit composed of one or more components grouped according to a configuration or function of the vehicle 100. For example, a platform of the vehicle 100 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100 different from the platform may be modularized. Various modules may include an arbitrary exterior component such as a bumper or a grill, or an arbitrary interior component such as a seat or a console. Not only the vehicle 100 but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

(D10) A configuration for realizing running of a vehicle by unmanned driving is also called a “Remote Control auto Driving system”. Conveying a vehicle using Remote Control Auto Driving system is also called “self-running conveyance”. Producing the vehicle using self-running conveyance is also called “self-running production”. In self-running production, for example, at least part of the conveyance of vehicles is realized by self-running conveyance in a factory where the vehicle is manufactured.

(D11) The control and the method described in the present disclosure may be realized by a dedicated computer provided by configuring a processor and a memory programmed in such a manner as to implement one or a plurality of functions embodied by a computer program. Alternatively, the controller and the method described in the present disclosure may be realized by a dedicated computer provided by configuring a processor using one or more dedicated hardware logic circuits. Still alternatively, the controller and the method described in the present disclosure may be realized by one or more dedicated computers configured using a combination of a processor and a memory programmed in such a manner as to implement one or a plurality of functions, and a processor configured using one or more hardware logic circuits. The computer program may be stored as an instruction to be executed by a computer into a computer-readable tangible non-transitory recording medium.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof.

What is claimed is:

1. A server device, comprising:
a command generation unit configured to generate a running command for controlling running of a vehicle by unmanned driving;
a command transmission unit configured to control transmission of the running command to the vehicle;
a stopping detection unit configured to detect that the vehicle has been stopped at an assembly position where a part is assembled onto the vehicle; and
a stopping unit configured to perform at least one of a process of stopping the generation of the running command by the command generation unit, a process of stopping the transmission of the running command by the command transmission unit, and a process of transmitting to the vehicle a deactivation command that disables the running command, when it is detected that the vehicle has been stopped at the assembly position.

2. The server device according to claim 1, further comprising:
an assembly detection unit configured to detect that assembly of the part has been completed; and
a restarting unit configured to perform at least one of a process of restarting the process or processes stopped by the stopping unit and a process of transmitting to the vehicle an activation command that activates the running command, when it is detected that the assembly of the part has been completed.

3. The server device according to claim 2, wherein
the assembly detection unit is configured to detect that the assembly of the part has been completed using information acquired from an assembly device that assembles the part onto the vehicle.

4. The server device according to claim 3, wherein
the assembly device includes an arm unit that assembles the part onto the vehicle, and
the assembly detection unit is configured to detect that the assembly of the part has been completed using information regarding a state of the arm unit acquired from the assembly device.

5. The server device according to claim 4, wherein
the state of the arm unit is a state regarding a position and an orientation of the arm unit.

6. The server device according to claim 4, wherein
the state of the arm unit is a state whether the arm unit is gripping the part.

7. The server device according to claim 2, wherein
the assembly detection unit is configured to detect that the assembly of the part has been completed using information acquired from an external sensor located outside the vehicle.

8. The server device according to claim 2, wherein
the assembly detection unit is configured to detect that the assembly of the part has been completed using a pass/fail determination result regarding the assembly of the part.

9. The server device according to claim 2, wherein
the assembly detection unit is configured to detect that the assembly of the part has been completed using information transmitted from the vehicle when the part has been assembled.

10. A vehicle capable of running by unmanned driving, comprising:
an actuator configured to cause the vehicle to run;
a command generation unit configured to generate a running command for controlling running of the vehicle by unmanned driving;
a control unit configured to drive the actuator using the running command;
a stopping detection unit configured to detect that the vehicle has been stopped at an assembly position where a part is assembled onto the vehicle; and
a stopping unit configured to perform at least one of a process of stopping the generation of the running command by the command generation unit, and a process of stopping the driving of the actuator using the running command by the control unit, when it is detected that the vehicle has been stopped at the assembly position.
